(19) United States
(12) Patent Application Publication
(10) Pub. No.: US 2016/0103847 A1
(43) Pub. Date: Apr. 14, 2016

(54) METHOD FOR PROVIDING SEARCH KEYWORD AND ELECTRONIC DEVICE SUPPORTING THE SAME

(71) Applicant: Samsung Electronics Co., Ltd., Gyeonggi-do (KR)

(72) Inventors: Jiwoo LEE, Gyeongsangbuk-do (KR); Sunghyun KYUNG, Daegu (KR); Jaeho LEE, Daegu (KR)

(73) Assignee: Samsung Electronics Co., Ltd.

(21) Appl. No.: 14/882,718

(22) Filed: Oct. 14, 2015

(30) Foreign Application Priority Data
Oct. 14, 2014 (KR) 10-2014-0138410

(51) Int. Cl. G06F 17/30

(52) U.S. Cl. CPC G06F 17/3087; G06F 17/30696; G06F 17/30648

(57) ABSTRACT

A method for providing a search keyword and an electronic device supporting the same is provided. The method for providing, by an electronic device, a search keyword, the method includes displaying search results comprising at least one item in response to an entry of a first search keyword into a search keyword entry region, determining continuity between the first search keyword and a second search keyword which is a search keyword entered prior to the first search keyword, and storing at least one of the first search keyword and a search formula, in which the first search keyword and the second search keyword have been combined in a search keyword list, in response to the determination of the continuity between the first search keyword and the second search keyword.

### PRIORITY

This application claims priority under 35 U.S.C. §119(a) to a Korean Patent Application filed on Oct. 14, 2014, in the Korean Intellectual Property Office and assigned Serial No. 10-2014-0138410, the entire disclosure of which is incorporated herein by reference.

### BACKGROUND

1. Field of the Invention

The present invention relates generally to a method for providing a search keyword and an electronic device supporting the same.

2. Description of the Related Art

An electronic device provides a search function capable of searching for data stored in the electronic device. An electronic device may store a search keyword on which a search function has been performed in a search keyword list. A user may check search histories arranged in order of search chronology through the search keyword list. Furthermore, a user may search for a previously stored search keyword again through the search keyword list.

An electronic device may sequentially delete stored search keywords according to search sequence and frequency in order to efficiently use the limited storage space of a search keyword list. Some search keywords deleted from such a sequential deletion process may be search keywords that have provided necessary information to a user or search keywords that have provided unnecessary information to the user. Accordingly, if search keywords that have provided necessary information to a user are deleted from a search keyword list, there may be a problem in that the user has to input a deleted search keyword again in order to obtain the same information or the user is unable to accurately select a search keyword that has provided necessary information from a plurality of search keywords included in the search keyword list.

### SUMMARY

The present invention has been made to address at least the problems and disadvantages described above, and to provide at least the advantages described below.

Accordingly, an aspect of the present invention is to provide a method for providing a search keyword in which the validity of an entered search keyword is determined based on a user gesture for a search result.

Accordingly, another aspect of the present invention is to provide necessary search information to a user through a search keyword list based on consecutively entered search keywords

Accordingly, another aspect of the present invention is to improve accessibility and accuracy of search results to be obtained by a user by providing an effective search formula into which a user's intention has been incorporated.

Accordingly, another aspect of the present invention is to efficiently manage a limited search keyword list by classifying a search keyword as a target search keyword or a candidate search keyword and storing the search keyword and by determining a valid search keyword.

Accordingly, another aspect of the present invention is to improve usefulness and diversity of information by sharing a search keyword list and search results with an external electronic device connected to an electronic device over a network.

In accordance with an aspect of the present invention, a method for providing, by an electronic device, a search keyword, is provided. The method includes displaying search results comprising at least one item in response to an entry of a first search keyword into a search keyword entry region, determining continuity between the first search keyword and a second search keyword which is a search keyword entered prior to the first search keyword, and storing at least one of the first search keyword and a search formula, in which the first search keyword and the second search keyword have been combined in a search keyword list, in response to the determination of the continuity between the first search keyword and the second search keyword.

In accordance with another aspect of this invention, an electronic device is provided. The electronic device includes a communication unit configured to connect the electronic device and an external electronic device, a storage unit configured to store a search keyword entered into a search keyword entry region and a search keyword list received from the external electronic device, a touch screen configured to display search results including at least one item in response to the entry of a first search keyword into the search keyword entry region, and a control unit configured to determine continuity between the first search keyword and a second search keyword entered prior to the first search keyword and to store at least one of the first search keyword and a search formula, in which the first search keyword and the second search keyword have been combined in a search keyword list, in response to the determination of the continuity between the first search keyword and the second search keyword.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram of a configuration of an electronic device, according to an embodiment of the present invention;

FIGS. 2A and 2B are diagrams illustrating a method for determining a valid gesture and an invalid gesture based on a user gesture detected in search results, according to an embodiment of the present invention;

FIG. 3 is a flowchart of a method for providing a search keyword, according to an embodiment of the present invention;

FIGS. 4A to 4C are diagrams illustrating a method for storing a search keyword in a search keyword list, according to an embodiment of the present invention;

FIGS. 5A to 5C are diagrams illustrating a method for displaying a previously stored search keyword in a search keyword list, according to an embodiment of the present invention;

FIG. 6 is a diagram illustrating a method for determining temporal and spatiotemporal continuity, according to an embodiment of the present invention;

FIG. 7 is a diagram illustrating a method for configuring a search formula and storing the configured search formula in a search keyword list, according to an embodiment of the present invention;

FIG. 8 is a diagram illustrating a method for displaying search results of a search formula, according to an embodiment of the present invention; and

FIG. 9 is a flowchart of a method for determining a target search keyword and a candidate search keyword based on a search keyword shared between electronic devices, according to an embodiment of the present invention.

### DETAILED DESCRIPTION OF EMBODIMENTS OF THE PRESENT INVENTION

Hereinafter, various embodiments of the present invention are described with reference to the accompanying drawings. However, the various embodiments are not intended to restrict the present invention to specific embodiments, but should be interpreted as including various modifications, equivalents and/or alternatives of the present invention. In relation to a description of the drawings, similar reference numerals may be used in similar elements.

In this document, expressions, such as “have”, “may have”, “include”, or “may include”, indicate the presence of a corresponding characteristic (e.g., an element, such as a number, a function, an operation, or a part), but do not exclude the presence of additional characteristics.

In this disclosure, expressions, such as “A or B”, at least one of “A and/or B”, or one or more of “A and/or B”, may include all possible combinations of the listed items. For example, “A or B”, at least one of “A and B”, or at least one of “A or B” may indicate all of (1) a case where A is included, (2) a case where B is included, and (3) a case where both A and B are included.

Expressions, such as “a first”, “a second”, “the first”, and “the second”, used herein, may describe various elements irrespective of their sequence and/or importance and do not limit the corresponding elements. The expressions may be used to distinguish one element from the other element. For example, a first user device and a second user device may refer to different user devices irrespective of their sequence or importance. For example, a first element may be referred to as a second element and the second element may be referred to as the first element without departing from the scope of the present invention.

When it is described that one element (e.g., a first element) is operatively or communicatively “coupled” with/to the another element (e.g., a second element), it should be understood that the first element may be directly coupled with/to the second element or may be coupled with/to the second element through another element (e.g., a third element). In contrast, when it is described that the first element is “directly coupled” with/to the second element, it should be understood that a third element is not present between the first element and the second element.

The expression “configured (or set) to”, as used in this disclosure, may be replaced with an expression, such as “suitable for”, “having the capacity to”, “designed to”, “adapted to”, “made to”, or “capable of”, according to the circumstance. The expression a “device configured (or set) to” is not intended to only mean “specifically designed to” in terms of hardware. Instead, in some circumstances, the expression may refer to a device that “performs” along with other devices or parts. For example, a “processor configured (or set) to perform phrases A, B, and C”, may refer to a dedicated processor (e.g., an embedded processor) for performing a corresponding operation or a generic-purpose processor (e.g., a CPU or application processor) capable of performing corresponding operations by executing one or more software programs stored in a memory device.

Terms used in this disclosure are used to only describe specific embodiments and are not be intended to restrict the scope of other embodiments. An expression in the singular form includes an expression in the plural form unless clearly defined otherwise in the context. All terms used herein, including technical terms or scientific terms, have meanings equivalent to those generally understood by persons of ordinary skill in the technical field to which the present invention pertains. Terms that are generally used and defined in dictionaries, should be construed as having the same meanings as those that are used in the context of related technology and should not be construed as having ideal or excessively formal meanings unless explicitly defined otherwise. Terms used herein should not be interpreted as excluding the embodiments of the present invention although the terms have been defined in this disclosure.

An electronic device, according to various embodiments of the present invention, may include at least one of a smart phone, a tablet personal computer (PC), a mobile phone, a video telephone, an e-book reader, a desktop PC, a laptop PC, a netbook computer, a workstation, a server, a personal digital assistant (PDA), a portable multimedia player (PMP), an MP3 player, a mobile medical device, a camera, and a wearable device (e.g., smart glasses, a head-mounted-device (HMD), electronic clothing, an electronic bracelet, an electronic necklace, an electronic appcessory, an electronic tattoo, a smart mirror, or a smart watch).

In some embodiments, the electronic device may be a smart home appliance. The smart home appliance may include at least one of television, a digital versatile disk (DVD) player, an audio device, a refrigerator, an air-conditioner, a cleaner, an oven, a microwave, a washing machine, an air cleaner, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, and an electronic picture frame, for example.

In another embodiment, the electronic device may include at least one of various medical devices (e.g., various portable medical measuring devices (e.g., a blood glucose monitoring device, a heart rate monitor, a blood pressure measuring device, and a body temperature measuring instrument), magnetic resonance angiography (MRA) scanner, magnetic resonance imaging (MRI) scanner, computed tomography (CT) scanner, a tomography scanner, and an ultrasonic machine), a navigator, a global positioning system (GPS) receiver, an event data recorder (EDR), a flight data recorder (FDR), a vehicle infotainment device, electronic equipment for a ship (e.g., a navigator for a ship and a gyro compass), avionics, security devices, a head unit for a vehicle, industry or home robots, an automatic teller machine (ATM), a point of sale (POS) machine, and an Internet of Things (IoT) device (e.g., a bulb, a sensor, an electric or gas meter, a sprinkler device, a fire alarm, a thermostat, a streetlamp, a toaster, a health machine, a hot water tank, a heater, and a boiler).

In some embodiments, the electronic device may include at least one of part of furniture or a building/structure, an electronic board, an electronic signature receiving device, a projector, and various measuring devices (e.g., water supply, electricity, gas, and wave metering devices).

In various embodiments of the present invention, the electronic device may be a combination of one or more of the above-described various devices. The electronic device may be a flexible electronic device. Furthermore, the electronic device is not limited to the above-described devices and may include new electronic devices according to the development of a technology.

The electronic device, according to various embodiments of the present invention, is described below with reference to the accompanying drawings. As used herein, the term “user” may refer to a person who uses the electronic device or a device (e.g., an artificial intelligence electronic device) which uses the electronic device.

According to an embodiment of the present invention, a search keyword entry region is a region in which a search keyword entered by a user is displayed in the electronic device if a search function is performed. When input for selecting the search keyword entry region is detected, the electronic device displays a search keyword list. Furthermore, when input for selecting the search keyword entry region is detected, the electronic device displays an input device, such as a virtual keyboard or a keypad. When the input device is displayed, the electronic device inputs a search keyword to the search keyword entry region through the input device.

Furthermore, in an embodiment of the present invention, a search keyword list is a list in which search keywords (e.g., search keywords entered into a search keyword entry region), on which a search function has been performed, have been sequentially stored. A specific number of search keywords may be stored in the search keyword list. The electronic device displays a target search keyword and candidate search keywords based on a user gesture detected in the search results of a search keyword entered into the search keyword entry region and stores them in the search keyword list. The electronic device searches the search keyword list for a search keyword in response to an unfinished search keyword entered into the search keyword entry region. If the number of search keywords stored in the search keyword list exceeds a specific number, the electronic device deletes candidate search keywords from search keywords stored in the search keyword list, in preference of target search keywords.

Furthermore, in an embodiment of the present invention, the validity of a search keyword is determined based on whether a user gesture detected in the search results of the search keyword entered into a search keyword entry region is a valid gesture or an invalid gesture. The electronic device determines whether the search keyword is a target search keyword or a candidate search keyword based on the validity of the search keyword. For example, when selection input (e.g., a tap or a double tap gesture) for selecting at least one item from the search results is detected, the electronic device determines the selection input to be a valid gesture. That is, the selection input for selecting the at least one item from the search results may be input for viewing the contents of the selected search result in detail. When a valid gesture for the search result is detected, the electronic device determines the search keyword to be a target search keyword. The results of the search may include items, such as multimedia content, including a still image and/or a moving image, link information about an access page, a text message, user log information, an application icon, and user content, such as notes or memos.

Alternatively, when a gesture (e.g., a scroll, a drag, or a flick gesture) for viewing a list of the search results other than a gesture corresponding to the selection input, is detected in the search results, the electronic device determines the gesture to be an invalid gesture. When the invalid gesture for the search results is detected, the electronic device determines the search keyword to be a candidate search keyword.

Furthermore, in an embodiment of the present invention, continuity of a search keyword may be determined based on whether there is continuity between a search keyword entered into a search keyword entry region and a previously entered search keyword in a search keyword list. The electronic device compares temporal continuity and/or spatiotemporal continuity of the entered search keyword with those of the previously entered search keyword. The electronic device determines whether the entered search keyword and the previously entered search keyword has continuity based on the comparison.

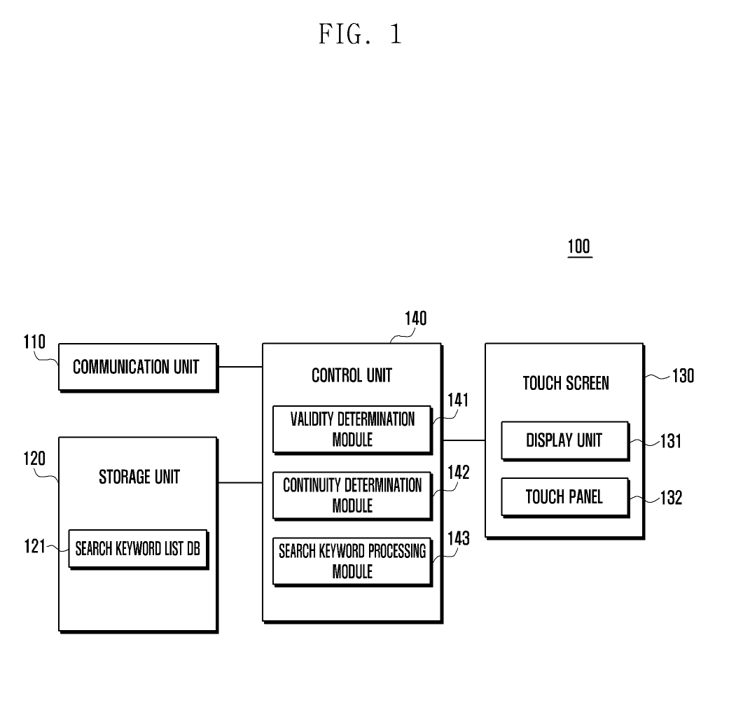

FIG. 1 is a diagram of a configuration of an electronic device, according to an embodiment of the present invention.

Referring to FIG. 1, an electronic device 100 is provided. The electronic device 100 includes a communication unit 110, a storage unit 120, a touch screen 130, and a control unit 140.

The communication unit 110 performs a voice call, video call, or data communication with an external device over a network. The communication unit 110 may include an RF transmitter configured to perform up-conversion and amplification on the frequency of a transmitted signal and an RF receiver configured to perform low-noise amplification on a received signal and perform down-conversion on the frequency of the signal. Furthermore, the communication unit 110 may include a modulator and a demodulator. The modulator and the demodulator may include code division multiple access (CDMA), wideband CDMA (WCDMA), long term evolution (LTE), Wi-Fi, wireless broadband (WIBRO), Bluetooth, and near field communication (NFC). The communication unit 110 may be a mobile communication module, an Internet communication module, and/or a short-distance communication module.

In particular, according to an embodiment of the present invention, the communication unit 110 may communicate with an external electronic device under the control of the electronic device 100. The communication unit 110 requests the search results of a search keyword entered into the search keyword entry region of the electronic device from the external electronic device under the control of the electronic device 100. The communication unit 110 receives the search results from the external electronic device as a response to the search request under the control of the electronic device 100. Furthermore, the communication unit 110 requests a search keyword list from the external electronic device under the control of the electronic device 100. The communication unit 110 receives the search keyword list from the external electronic device as a response to the request for the search keyword list under the control of the electronic device 100.

The storage unit 120 may include program memory for storing the operation programs of the electronic device 100 and data memory for storing log information generated when a program is performed and data, such as content.

In particular, in an embodiment of the present invention, the storage unit includes a search keyword list database (DB) 121.

The search keyword list DB 121 stores a search keyword entered into a search keyword entry region when the search keyword is searched for through a search function (e.g., by executing a search application) under the control of the electronic device 100. The search keyword list DB 121 stores a search keyword list received from an external electronic device connected to the electronic device 100 through the communication unit 110 under the control of the electronic device 100.

The touch screen 130 may be configured in an integrated type including a display unit 131 and a touch panel 132. The display unit 131 may display various screens according to the use of the electronic device 100. Furthermore, the display unit 131 may include a liquid crystal display (LCD), a light-emitting diode (LED) display, an organic light-emitting diode (OLED) display, a microelectromechanical systems (MEMS) display, or an electronic paper display. For example, the display unit 131 displays a variety of types of content (e.g., text, images, videos, icons, and symbols) to a user. The touch panel 132 may receive a touch, a gesture, proximity, or hovering input using an electronic pen or part of the body of a user, for example.

In particular, according to an embodiment of the present invention, when input for selecting a search keyword entry region is detected, the display unit 131 displays a search keyword list stored in the storage unit 120 under the control of the electronic device 100. The touch panel 132 detects the entry of a first search keyword to the search keyword entry region under the control of the electronic device 100. In response to the entry of the first search keyword, the display unit 131 displays the search results of the first search keyword under the control of the electronic device 100. The touch panel 132 detects a selection input for selecting the search results under the control of the electronic device 100. In response to the selection input, the display unit 131 displays a screen in which an application corresponding to the selected search results has been executed under the control of the electronic device 100.

The control unit 140 controls an overall operation of the electronic device 100 and a flow of signals between the internal elements of the electronic device 100, performs data processing, and controls the supply of power from a battery to the elements of the electronic device 100.

In particular, according to an embodiment of the present invention, the control unit 140 includes a validity determination module 141, a continuity determination module 142, and a search keyword processing module 143.

The control unit 140 detects the entry of a first search keyword to a search keyword entry region displayed as a result of the execution of a search function. In response to the entry of the first search keyword, the control unit 140 controls the display unit 131 to display the search results of the first search keyword. The control unit 140 detects a user gesture in the displayed search results. When the user gesture is detected, the control unit 140 determines the validity of the search keyword through the validity determination module 141. The control unit 140 determines the first search keyword to be a target search keyword or a candidate search keyword based on a result of the determination of the validity of the search keyword.

If the user gesture is a selection input for selecting the search results, the validity determination module 141 determines the user gesture to be a valid gesture and determines the search keyword to be a target search keyword.

If the user gesture is not a selection input for selecting the search results, the validity determination module 141 determines the user gesture to be an invalid gesture and determines the search keyword to be a candidate search keyword.

If the first search keyword is determined to be a target search keyword, the control unit 140 determines continuity between the first search keyword and a previous search keyword (e.g., a search keyword most recently stored in a search keyword list) through the continuity determination module 142.

The continuity determination module 142 determines temporal continuity and/or spatiotemporal continuity between the first search keyword and the previous search keyword (i.e., a second search keyword). If a difference between the recording time of the first search keyword and the recording time of the second search keyword is within a predetermined time span, the continuity determination module 142 determines that the first search keyword and the second search keyword have temporal continuity. If the second search keyword is a search keyword shared with an external electronic device connected to the electronic device 100 and the electronic device 100 has requested a search for the second search keyword from the external electronic device within a predetermined time span, the continuity determination module 142 determines that the first search keyword and the second search keyword have spatiotemporal continuity.

The search keyword processing module 143 performs a search for a search keyword entered into a search keyword entry region. If it is determined the first search keyword and the second search keyword have continuity through the continuity determination module 142, the search keyword processing module 143 may configure a search formula in which the first search keyword and the second search keyword have been combined. The search keyword processing module 143 performs a search for a search keyword based on a result of the continuity determination of the continuity determination module 142 and/or the search formula. Furthermore, the search keyword processing module 143 may replace the first search keyword with the search formula and store it in the search keyword list.

If the second search keyword is determined to be a candidate search keyword, the search keyword processing module 143 deletes the second search keyword from the search keyword list.

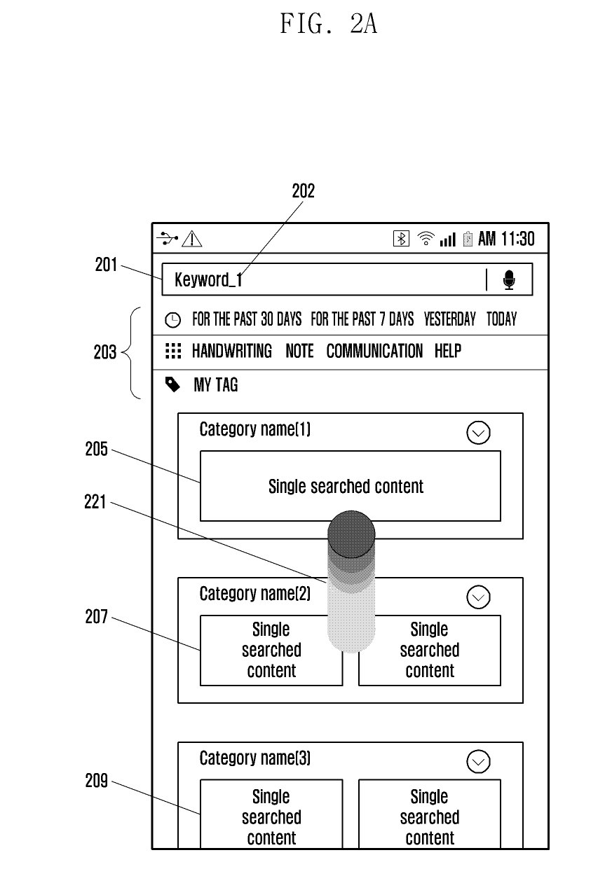

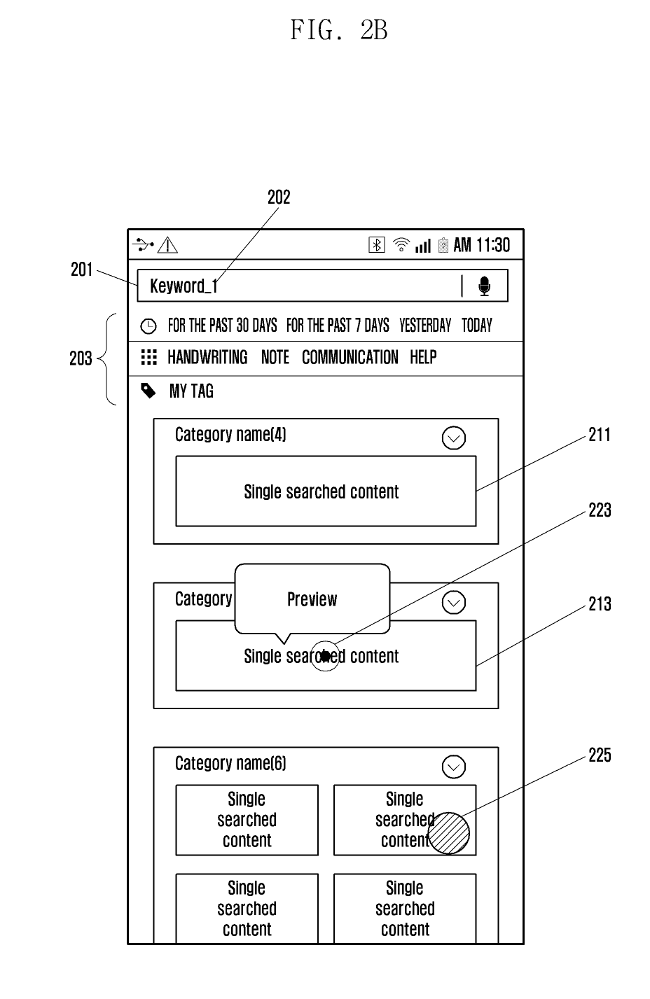

FIGS. 2A and 2B are diagrams illustrating a method for determining a valid gesture and an invalid gesture based on a user gesture detected in search results, according to an embodiment of the present invention.

Referring to FIGS. 2A and 2B, the electronic device 100 displays search results 205, 207, 209, 211, and 213 including at least one item of a search keyword 202, e.g., “Keyword_1”, entered into a search keyword entry region 201, by category.

The electronic device 100 may detect a gesture for selecting one of the search results 205, 207, 209, 211, and 213 displayed by category. The electronic device 100 performs an operation for viewing the contents of the search result 205, 207, 209, 211, and 213 (i.e., an operation for selecting the search result) through the gesture. In this case, the electronic device 100 determines the gesture to be a valid gesture. For example, when a gesture, such as a tap gesture 225, shown in FIG. 2B, for selecting a search result 205, 207, 209, 211, and 213 is detected, the electronic device 100 determines the tap gesture 225 to be a valid gesture.

Alternatively, the electronic device 100 may detect a gesture for viewing a list of the search results 205, 207, 209, 211, and 213 displayed by category. In this case, the electronic device 100 determines the gesture to be an invalid gesture. For example, when a gesture, such as a drag gesture 221, shown in FIG. 221 or a hovering gesture 223, shown in FIG. 223, for viewing a list of the search results 205, 207, 209, 211, and 213 is detected, the electronic device 100 determines the drag gesture 221 and the hovering gesture 223 to be invalid gestures. The invalid gesture may include a scroll gesture and a flick gesture in addition to the drag gesture and the hovering gesture.

In an embodiment of the present invention, if an operation for viewing the contents of search results 205, 207, 209, 211, and 213 (i.e., a valid gesture) is accompanied by an operation for viewing a list of the search results 205, 207, 209, 211, and 213 (i.e., an invalid gesture), although the invalid gesture is detected, the electronic device 100 determines the invalid gesture to be a valid gesture.

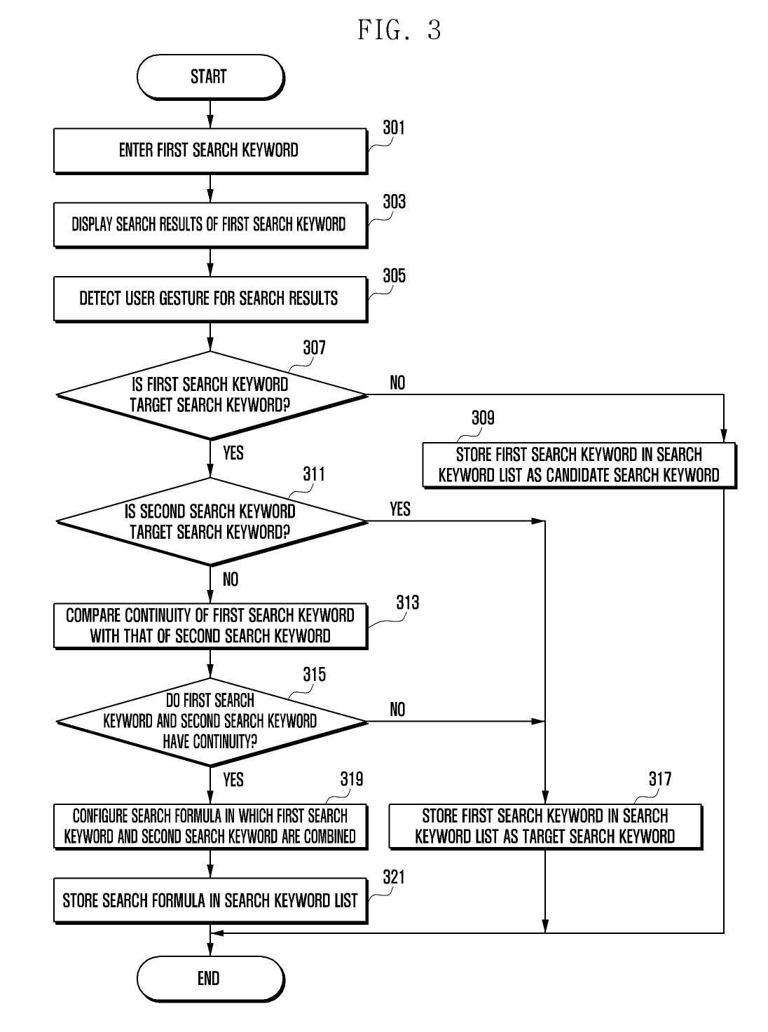

FIG. 3 is a flowchart of a method for providing a search keyword, according to an embodiment of the present invention.

Referring to FIG. 3, the electronic device 100 detects a search function request. For example, an operation for detecting the search function request may be an operation for executing an application (e.g., S Finder) installed in the electronic device 100.

When the search function request is detected, the electronic device 100 may detect an input of a search keyword. Each search keyword is stored in a keyword list. In step 301, a first search keyword is entered and detected. The first search keyword refers to the currently entered search keyword. A search keyword previously stored in the search keyword list is referred to as a second search keyword. Accordingly, a second search keyword may have been entered before the first search keyword is entered at step 301.

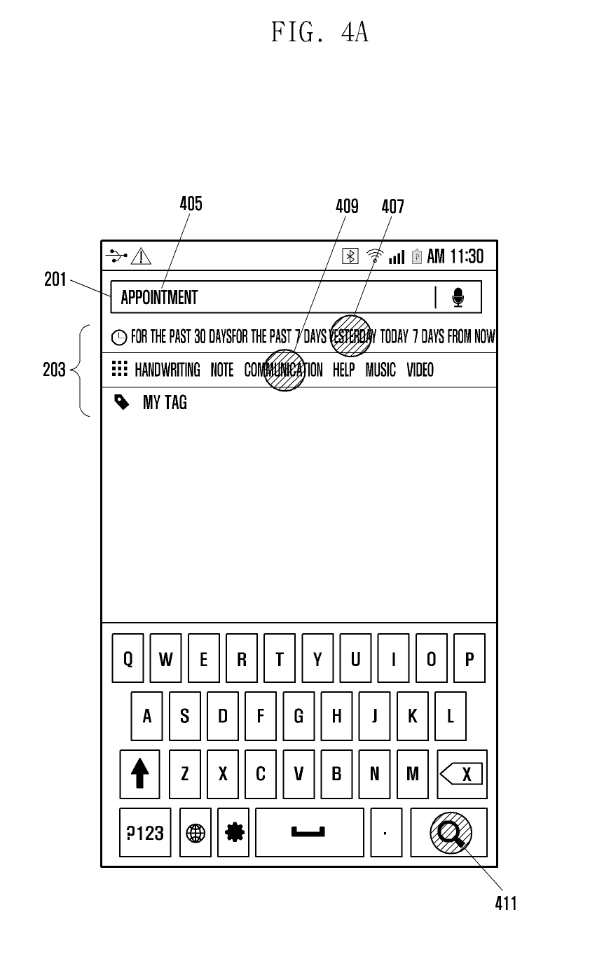

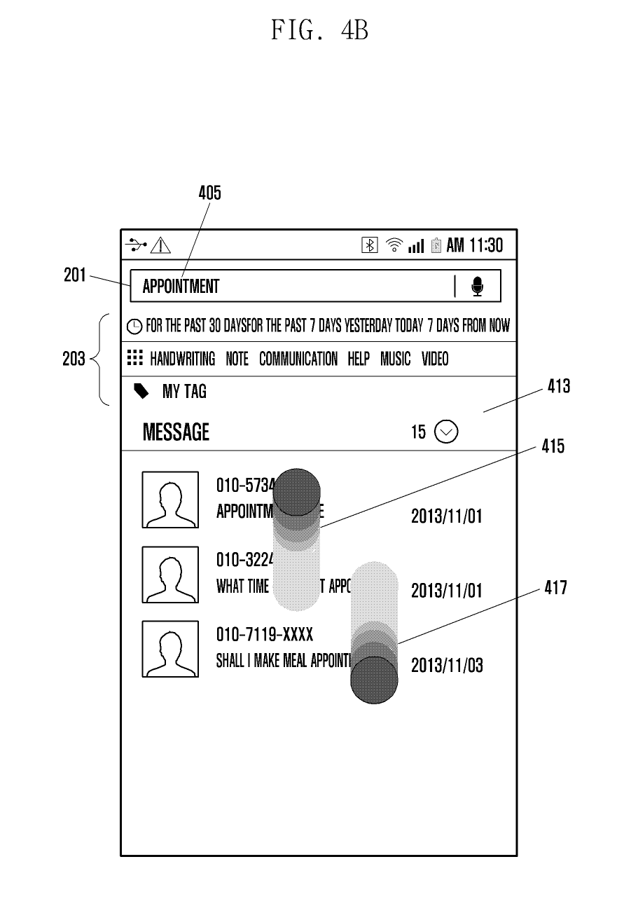

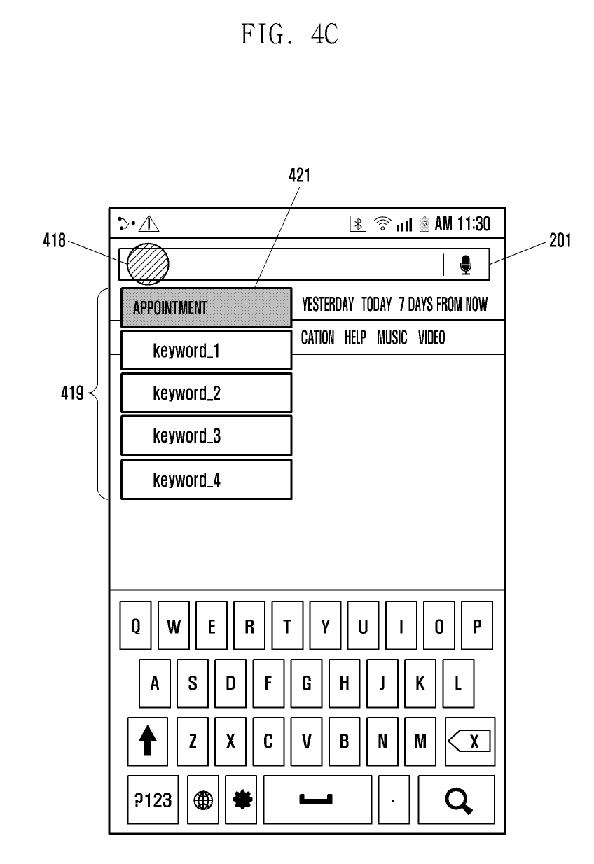

FIGS. 4A to 4C are diagrams illustrating a method for storing a search keyword in a search keyword list, according to an embodiment of the present invention.

Referring to FIGS. 4A to 4C, the electronic device 100 may detect an input 411 for entering a search keyword 405 (e.g., “Appointment”) to a search keyword entry region 201 and may perform a search by applying search filters, such as Yesterday 407 and/or Communication 409, in a search filter region 203, as shown in FIG. 4A. In response to the input 411 or the entry of the search keyword 405, the electronic device 100 displays the search results 413 for the search keyword 405 (i.e., “Appointment”) to which the search filters of Yesterday 407 and Communication 409 have been applied, as shown in FIG. 4B. For example, as shown in FIG. 4, the electronic device 100 controls the display unit 131 to display the search results 413 as a list of messages.

The electronic device 100 may detect a downward drag gesture 415 and/or an upward drag gesture 417 in the search results 413. The downward drag gesture 415 and the upward drag gesture 417 are gestures for viewing the list of the search results 413, and are not a selection input for selecting the search result 413. Accordingly, the electronic device 100 determines the downward drag gesture 415 and the upward drag gesture 417 to be invalid gestures. As a result, the electronic device 100 determines the search keyword 405 (i.e., “Appointment”) for which an invalid gesture has been detected to be a candidate search keyword.

When a touch input 418 is detected in the search keyword entry region 201, the electronic device 100 displays a search keyword list 419, containing previously stored search keywords, as shown in FIG. 4C. The search keyword 405 (i.e., “Appointment”) has been stored in the search keyword list 419 as a candidate search keyword. The electronic device 100 displays candidate search keywords differently from target search keywords, by applying, for example, a shadow effect, an underline effect, and/or an inversion effect to the candidate search keyword.

Referring back to FIG. 3, when the search function request is detected, the electronic device 100 detects the entry of a first search keyword at step 301, as described above. A method of entering the first search keyword includes a text input method using an input device, a voice input method using a microphone, a handwriting input method using a pen, a search keyword selection input method using the search keyword list, and a method for entering a search keyword using copy and paste.

The search keyword list may include search keywords, stored in a search keyword list of an external electronic device (e.g., a wearable device) connected to the electronic device 100 through the communication unit 110, in addition to search keywords stored in the electronic device 100. That is, the electronic device 100 and an external electronic device connected to the electronic device 100 through the communication unit 110 may share search keyword lists.

Furthermore, the electronic device 100 may receive a selection for various search filters displayed in the search filter region 203 for the first search keyword. For example, the search filter region 203 may include search filters for the time, user-designated tags, applications (e.g., music, a moving image, and a photo), and location.

When the entry of the first search keyword is detected, the electronic device 100 performs a search for the first search keyword. After performing a search for the first search keyword, the electronic device 100 controls the display unit 131 to display the search results according to the first search keyword and the set search filters in the search filter region 203 at step 303. The search results may include data resulting from the execution of an application (e.g., capturing a photo, downloading music, or writing a memo) within the electronic device 100 and/or data received from an external electronic device that is related to the first search keyword.

If an external electronic device is connected to the electronic device 100 through the communication unit 110, a search keyword list and/or search results may be shared between the electronic device 100 and the external electronic device.

The electronic device 100 may display only summary information of the search results including the first search keyword. The electronic device 100 may display search results, displaying only the summary information, in a list or thumbnail form, for example. Furthermore, the electronic device 100 may sort the search results by category and display the sorted search results. In an embodiment of the present invention, the category is assumed to be an application installed in the electronic device 100, but the present invention is not limited thereto. The search results may alternatively be displayed in order of name, in order of size, according to the type of data (e.g., music or a moving image), or by electronic device if an external electronic device is connected to the electronic device 100.

When the search results of the first search keyword are displayed, the electronic device 100 may detect a user gesture for the search results at step 305. In this case, the user gesture may include a scroll, flick, drag, tap and/or hovering gesture.

The electronic device 100 may detect an input by a user (e.g., a tap gesture) for selecting one of the summarized search results or may detect an input (e.g., a drag gesture) for viewing a list of the summarized search results.

When the tap gesture is detected, the electronic device 100 may execute an application corresponding to the selected search result (i.e., the search result on which the tap gesture was detected) and display the results of the execution on a screen of the electronic device 100. The electronic device 100 controls the display unit 131 so that the entire contents of the selected search result are displayed through the execution of the application. For example, if the selected search result is a text message, the electronic device 100 displays the contents of the text message by executing a message application.

When a drag gesture is detected, the electronic device 100 performs an operation for viewing a list of the search results.

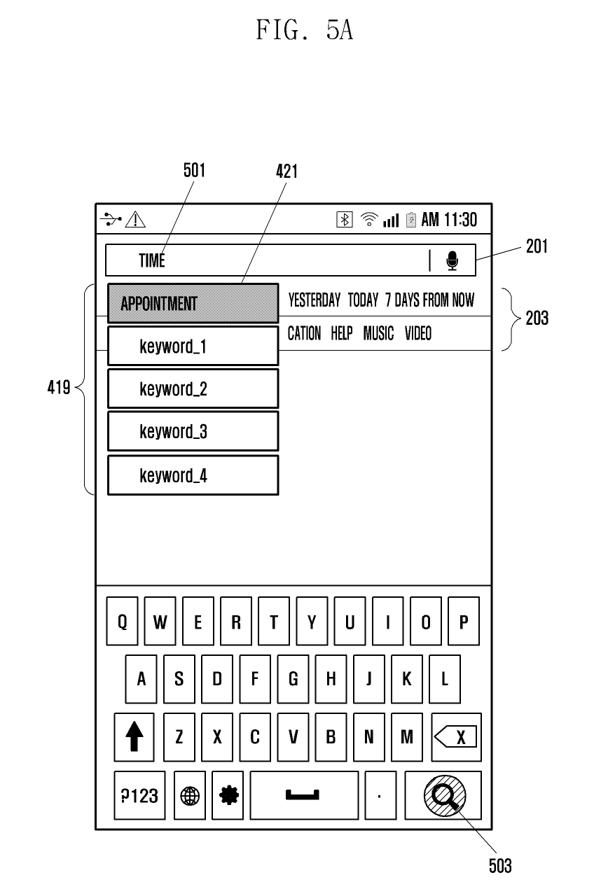

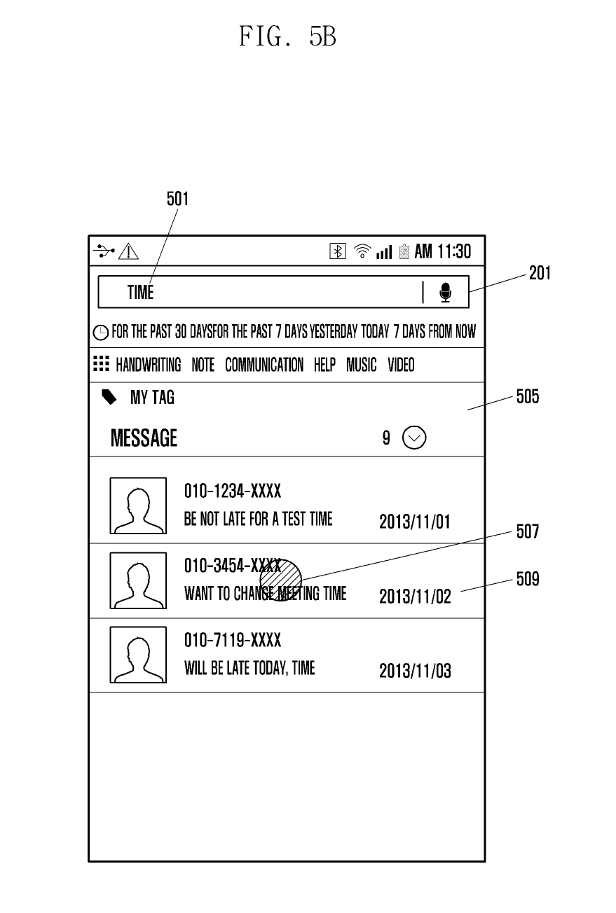

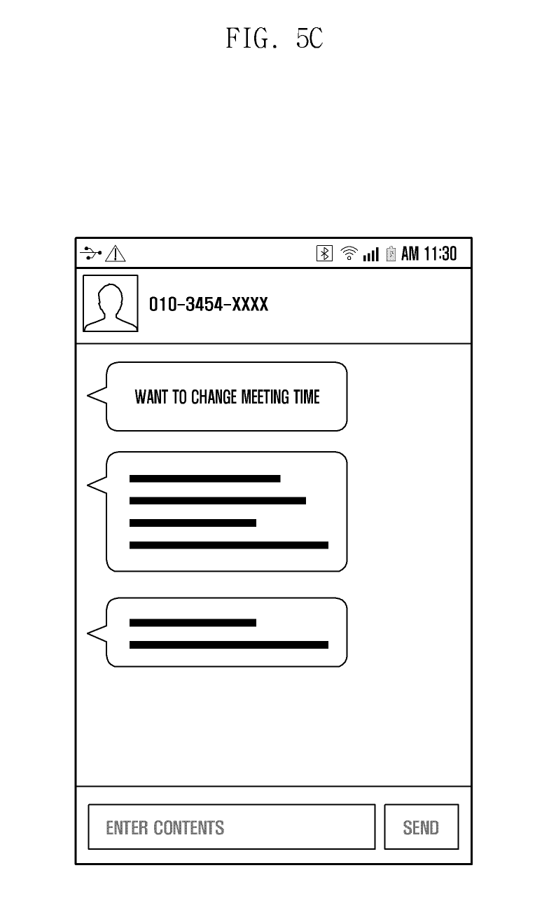

FIGS. 5A to 5C are diagrams illustrating a method for displaying a previously stored search keyword in a search keyword list, according to an embodiment of the present invention.

Referring to FIGS. 5A to 5C, the electronic device 100 detects an operation for entering a search keyword 501 (e.g., “Time”) to the search keyword entry region 201, as shown in FIG. 5A. Furthermore, the electronic device 100 detects an input 503 for searching for the search keyword 501 (e.g., “Time”). In response to the input 503 or the entry of the search keyword 501, the electronic device 100 performs an operation for searching for data related to the search keyword 501.

However, prior to performing the search operation for the search keyword 501, the electronic device 100 may have already searched for a previously entered search keyword 421 (e.g., “Appointment”), as shown in FIGS. 4A and 4B. In this case, the previously entered search keyword 421 was stored in the search keyword list 419 during a time of the previous search. As a result, when the operation for entering the search keyword 501 in the search keyword entry region 201 is detected, the electronic device 100 displays the search keyword list 419 with the search keyword 421 (e.g., “Appointment”), previously stored in the search keyword list 419, at the top of the search keyword list 419, as shown in FIG. 5A.

The electronic device 100 displays the search results 505 for the search keyword 501 (e.g., “Time”) in response to the search operation, as shown in FIG. 5B. Furthermore, the electronic device 100 may sort the search results application and display them. For example, as shown in FIG. 5B, the search results corresponding to the search keyword “Time” 501 are displayed as a summarized list based on a message application.

The electronic device 100 may detect a selection input 507 for selecting at least one item 509 of the search results 505. When the selection input 507 for selecting the one search result is detected, the electronic device 100 displays screen corresponding to the contents of the selected item 509. For example, as shown in FIG. 5C, the electronic device displays a message screen corresponding to the contents of the selected item 509 by executing the message application.

Referring back to FIG. 3, the electronic device 100 determines whether the first search keyword is a target search keyword based on the user gesture at step 307.

When a gesture (i.e., a valid gesture) for selecting a search result and executing an application for viewing the contents of the search results of the first search keyword is detected, the electronic device 100 determines the first search keyword to be a target search keyword.

When a gesture (i.e., an invalid gesture) for viewing a list of the search results is detected, without selecting a search result and executing an application, the electronic device 100 determines the entered first search keyword to be a candidate search keyword. Alternatively or additionally, if a search is terminated without the detection of a gesture, in the state in which the search results have been displayed, the electronic device 100 determines the entered first search keyword to be a candidate search keyword. The electronic device 100 stores the first search keyword in the search keyword list as a candidate search keyword at step 309.

If the first search keyword is stored in the search keyword list, the electronic device 100 may also store additional information about the search keyword. The additional information may include information about the search time and/or date of the search keyword, information about a search filter, information (ID) about a search person, information (MAC address) about a search terminal, information (ID) about an application, and information about a priority of keyword.

During the operation for determining whether a search keyword is a target search keyword or a candidate search keyword, an operation for determining a priority of search keywords in a search keyword list is performed. That is, the electronic device 100 assigns a priority to the first search keyword and stores the first search keyword in the search keyword list with the priority. The priority may be higher as the duration from the time the search keyword was entered becomes shorter (i.e., a later entered search keyword may have a higher priority than an earlier entered search keyword). Additionally, the priority may be higher for a target search keyword, than for a candidate search keyword. Since the priority is assigned as described, the electronic device 100 may delete candidate search keywords having a low priority when a previously stored search keyword is to be deleted, upon a new search keyword being generated, due to a limited number of search keywords that may be stored in a search keyword list. That is, if the number of search keywords that may be displayed (or stored) in a search keyword list is exceeded, the electronic device 100 may delete a previously stored search keyword (i.e., a search keyword searched for in the past). For example, the electronic device 100 may preferentially delete a search keyword having an earlier search time. When multiple search keywords belonging to the search keyword list have the same search time, since the electronic device 100 may assign a lower priority to a candidate search keyword than to a target search keyword, as described above, the candidate search keyword may be first deleted.

As a result the present invention provides search keywords in which a user's intention of priority has been incorporated because search keywords having high priority (i.e., target search keywords) are maintained in a search keyword list while, searching keywords with low priority (i.e., candidate search keywords) are deleted first, as described above.

When the first search keyword is a target search keyword, the electronic device 100 determines whether a previously stored second search keyword is a candidate search keyword or target search keyword, at step 311. The previously stored second search keyword may be a search keyword most recently stored in the search keyword list or may be a search keyword shared with an external electronic device. As described herein, the previously stored second search keyword is assumed to be a search keyword most recently stored in the search keyword list. If the second search keyword is a candidate search keyword, the electronic device 100 performs step 313. Otherwise, the electronic device 100 performs step 317. If the second search keyword is a candidate search keyword, the electronic device 100 performs an operation for comparing temporal and/or spatiotemporal continuity of the first search keyword with that of the second search keyword at step 313.

The electronic device 100 determines whether the first search keyword and the second search keyword have continuity at step 315.

If, as a result of the comparison, the first search keyword and the second search keyword do not have temporal continuity and/or spatiotemporal continuity, the electronic device 100 determines that the first search keyword and the second search keyword do not have continuity and proceeds to step 317; however, the present invention is not limited thereto.

If, as a result of the comparison, the first search keyword and the second search keyword have temporal continuity and/or spatiotemporal continuity, the electronic device 100 determines that the first search keyword and the second search keyword have continuity and proceeds to step 319.

In an embodiment of the present invention, if a difference between the recording time of the first search keyword and the recording time of the second search keyword is within a predetermined time span, the electronic device 100 determines that the first search keyword and the second search keyword have temporal continuity.

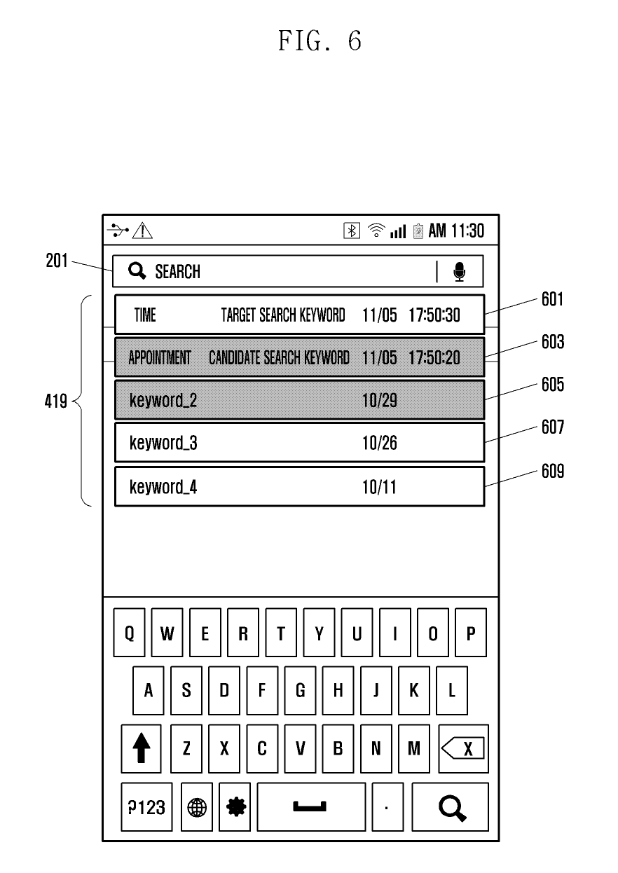

FIG. 6 is a diagram illustrating a method for determining temporal continuity and spatiotemporal, according to an embodiment of the present invention.

Referring to FIG. 6, when a touch input is detected in the search keyword entry region 201, the electronic device 100 displays the search keyword list 419. For example, the electronic device 100 displays the search keyword list 419, including search keywords “Time” 601, “Appointment” 603, “Keyword_2” 605, “Keyword_3” 607, and “Keyword_4” 609, as shown in FIG. 6. Furthermore, the electronic device 100 displays candidate search keywords “Appointment” 603 and “Keyword_2” 605 differently from target search keywords “Time” 601, “Keyword_3” 607, and “Keyword_4” 609 by applying a shadow effect to the candidate search keywords in the search keyword list 419.

The electronic device 100 determines whether there is temporal continuity by comparing the time span between a first search keyword and a second search keyword with a predetermined time span. For example, to determine whether there is temporal continuity between the search keyword “Time” 601 and the search keyword “Appointment” 603, the electronic device 100 determines the difference between the time that each search keyword was recorded. As shown in FIG. 6, the search keyword “Time” 601 was entered at 5:50:30 p.m. and the search keyword “Appointment” 603 was entered at 5:50:20 p.m. The predetermined time span is assumed to be 1 minute. A difference between the time when the search keyword “Time” 601 was recorded and the time when the search keyword “Appointment” 603 was recorded is 10 seconds, and the predetermined time span is 1 minute. Accordingly, the electronic device 100 determines that the difference is within the predetermined time span. As a result, the electronic device 100 determines that the search keywords “Time” 601 and “Appointment” 603 have temporal continuity.

In order to aid in the understanding of the present invention, a recording time has been assumed to be displayed along with a search keyword, but alternatively, the recording time may not be displayed. Furthermore, the predetermined time span may be previously set by the developer of the electronic device 100 or may be directly set by a user of the electronic device 100.

The electronic device 100 determines whether there is spatiotemporal continuity when the electronic device 100 is connected to an external electronic device through the communication unit 110. That is, an operation performing a comparison on spatiotemporal continuity may be applied to a search keyword list and/or search results shared with an external electronic device. Hereinafter, the electronic device 100 is assumed to be an electronic device A, and an external electronic device is assumed to be an electronic device B.

If a candidate search keyword from the electronic device B connected to the electronic device A is a second search keyword, i.e., a search keyword previously searched for in the electronic device A, and a first search keyword, that is, a target search keyword, is consecutively entered into the electronic device A or B, the electronic device A (i.e., electronic device 100) determines that the first search keyword and the second search keyword have spatiotemporal continuity.

In contrast, if a candidate search keyword from the electronic device B connected to the electronic device A is a second search keyword not having a search history in the electronic device A and a first search keyword, that is, a target search keyword, is consecutively entered into the electronic device A or B, the electronic device A (i.e., electronic device 100) determines that the first search keyword and the second search keyword do not have spatiotemporal continuity.

A method for determining temporal and/or spatiotemporal continuity between the first search keyword and the second search keyword is described with reference to Table 1.

TABLE 1

| Search histories of | | | | |
|---|---|---|---|---|
| electronic devices | | | | |
| A and B | Case 1 | Case 2 | Case 3 | Case 4 |
| First search keyword | A | A, B | A | A |
| Second search keyword | A | A | B | A, B |
| | (1 minute | (1 minute | (1 minute | (1 minute |
| | before) | before) | before) | before) |
| Spatiotemporal | Y | Y | N | Y |
| continuity? | | | | |
| Temporal | Y | Y | Y | Y |
| continuity? | | | | |

Referring to Table 1, in Case 1, the electronic device A may be in the state in which the entry of a first search keyword has been detected and a second search keyword has been entered one minute before the entry of the first search keyword. In this case, the electronic device 100 determines that the first search keyword and the second search keyword have temporal and spatiotemporal continuity.

In Case 2, the electronic devices A and B may have detected the entry of a first search keyword, and the electronic device A may be in the state in which a second search keyword has been entered one minute before the entry of the first search keyword. In this case, the electronic device 100 determines that the first search keyword and the second search keyword have temporal and spatiotemporal continuity.

In Case 3, the electronic device A may have detected the entry of a first search keyword, and the electronic device B may be in the state in which a second search keyword has been entered one minute before the entry of the first search keyword. In this case, the electronic device 100 determines that the first search keyword and the second search keyword have temporal continuity. In contrast, the electronic device 100, that is, the electronic device A, may detect the second search keyword from the electronic device B without a search history in the electronic device A. In this case, the electronic device 100 determines that the first search keyword and the second search keyword do not have spatiotemporal continuity.

In Case 4, the electronic device A may have detected the entry of a first search keyword, and the electronic devices A and B may be in the state in which a second search keyword has been entered one minute before the entry of the first search keyword. In this case, the electronic device 100 determines that the first search keyword and the second search keyword have temporal and spatiotemporal continuity.

Returning to FIG. 3, if it is determined that the first search keyword and the second search keyword do not have continuity, the electronic device 100 stores the first search keyword in the search keyword list as a target search keyword at step 317.

In contrast, if it determined that the first search keyword and the second search keyword have continuity, the electronic device 100 configures a search formula in which the first search keyword and the second search keyword have been combined at step 319.

An operation for configuring the search formula in which the first search keyword and the second search keyword have been combined may be an operation for configuring the second search keyword as a dependent search keyword of the first search keyword. For example, the search formula may be configured by a combination of “the first search keyword and the second search keyword.” That is, if the first search keyword and the second search keyword are different or do not have a correlation to one another (i.e. do not contain any of the same keywords), the electronic device 100 may configure a search formula as described above.

However, if the first search keyword and the second search keyword have a correlation, the electronic device 100 is unable to configure a search formula. For example, if the first search keyword is “time condition” and the second search keyword is “condition”, the electronic device 100 is unable to form a search formula because the search keywords “condition” from each of the first search keyword and the second search keyword are the same. In this case, the electronic device 100 stores the “time condition” in the search keyword list.

The electronic device 100 stores the search formula in the search keyword list at step 321. In this case, if the second search keyword is a candidate search keyword, the electronic device 100 may configure a search formula by combining the first search keyword and the second search keyword and delete the second search keyword from the search keyword list.

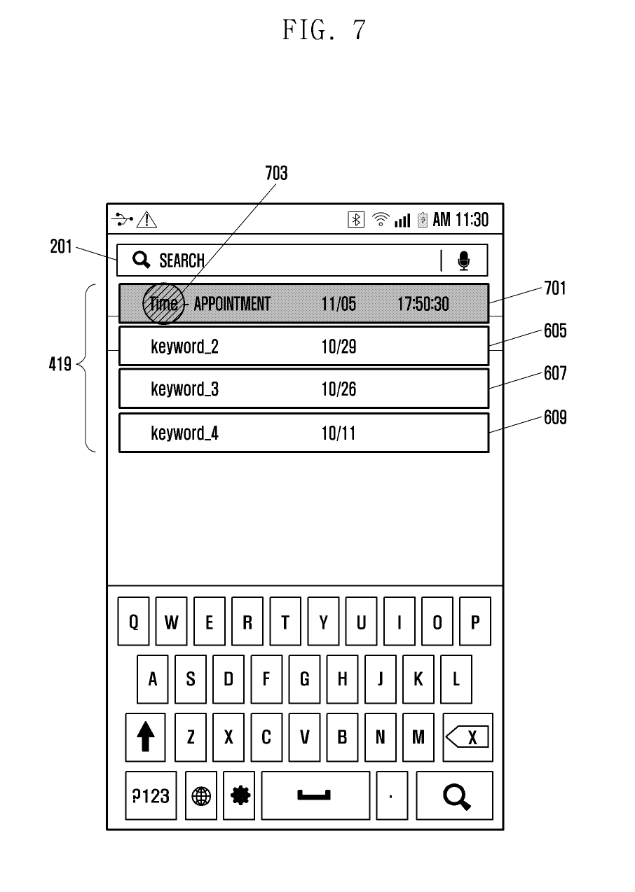

FIG. 7 is a diagram illustrating a method for configuring a search formula and storing the configured search formula in a search keyword list, according to an embodiment of the present invention.

Referring to FIG. 7, since the search keywords “Time” 601 and “Appointment” 603 have temporal continuity as described above, with reference to FIG. 6, the electronic device 100 may configure a search formula “Time—Appointment” by combining the two search keywords. Furthermore, the electronic device 100 stores the search formula as search keyword “Time—Appointment” 701 in the search keyword list 419 and deletes the search keyword “Appointment” 603. That is, the electronic device 100 displays the search keyword list 419, including the search keywords “Time—Appointment” 701, “Keyword_2” 605, “Keyword_3” 607, and “Keyword_4” 609.

After the search formula is stored in the search keyword list, when input for selecting the search keyword entry region 201 is detected, the electronic device 100 displays the search keyword list 419 including the search formula. When an input for selecting the search formula in the search keyword list 419 is detected, the electronic device 100 controls the display unit 131 to display the search results of the search formula. The electronic device 100 may display the search results of the search formula in preference to the search results of the first search keyword (or the second search keyword). The reason for this is that there is a good possibility that a user may want information including both the first search keyword and the second search keyword. That is, after the search results of the search formula are displayed, the electronic device 100 may sequentially display the search results of the first search keyword or the search results of the second search keyword.

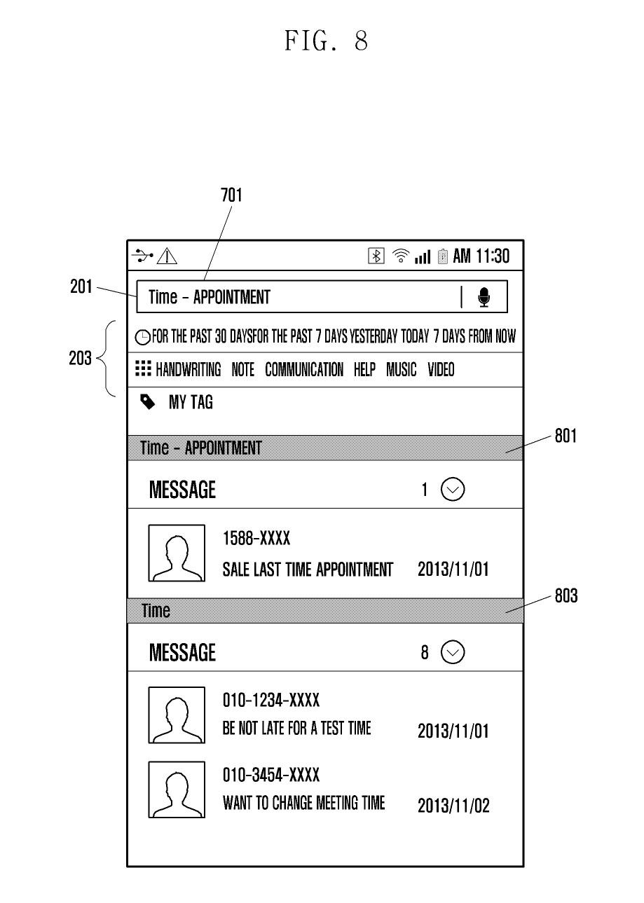

FIG. 8 is a diagram illustrating a method for displaying search results of a search formula, according to an embodiment of the present invention.

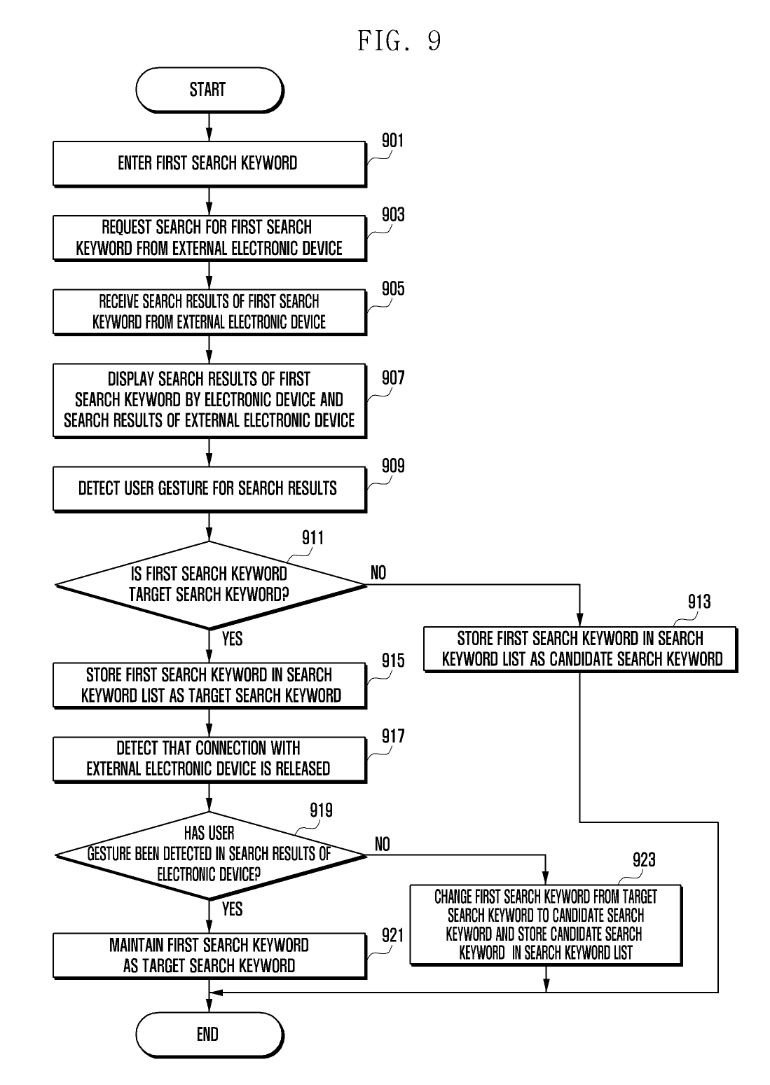

Referring to FIG. 8, first, the electronic device 100 detects an input 703, as shown in FIG. 7, for selecting “Time—Appointment” 701, that is, the search formula in which the two search keyword have been combined, in the search keyword list 419. In response to the input 703 for selecting the search formula “Time—Appointment” 701, the electronic device 100 displays the search results 801 of the search keyword “Time—Appointment” 701, as shown in FIG. 8. The electronic device 100 additionally sequentially displays the search results 803 of the search keyword “Time” 601. FIG. 9 is a flowchart of a method for determining a target search keyword and a candidate search keyword based on a search keyword shared between electronic devices, according to an embodiment of the present invention.

Referring to FIG. 9, the electronic device 100 is connected to an external electronic device (e.g., a wearable device) through the communication unit 110 and has shared a search keyword list and/or the search results of a search keyword.

The electronic device 100 detects the entry of a first search keyword at step 901.

When the entry of the first search keyword is detected, the electronic device 100 requests a search for the first search keyword from the external electronic device at step 903.

In response to the request for a search for the first search keyword, the electronic device 100 receives the search results of the first search keyword from the external electronic device at step 905.

When the search results of the first search keyword are received from the external electronic device, the electronic device 100 controls the display unit 131 to display both the search results of the first search keyword by the electronic device 100 and/or the search results received from the external electronic device at step 907. For example, the electronic device 100 controls the display unit 131 to display the search results of the electronic device 100 by category and then displays the search results of the external electronic device by category. Alternatively, the electronic device 100 may control the display unit 131 to merge the search results of the electronic device 100 and the search results of the external electronic device, sorts the merged search results by category, and displays them, but the present invention is not limited thereto.

The electronic device 100 detects a user gesture for the search results at step 909. That is, the electronic device 100 detects a user gesture in the search results of the electronic device 100 or detects a user gesture in the search results of the external electronic device. The user gesture may include a tap gesture, a drag gesture, a hovering gesture, a scroll gesture, and a flick gesture.

The electronic device 100 determines whether the first search keyword is a target search keyword at step 911.

When a gesture (e.g., a tap gesture) for selecting one of the search results of the electronic device 100 or the external electronic device is detected, the electronic device 100 determines the first search keyword to be a target search keyword. That is, when the electronic device 100 detects a selection input for selecting one of the search results, the electronic device 100 determines the first search keyword to be a target search keyword. In response to the selection input, the electronic device 100 displays the contents of the selected search result on a full screen by executing an application corresponding to the selected search result.

Alternatively, when a gesture (e.g., a drag gesture) for viewing a list of the search results of the electronic device 100 or a list of the search results of the external electronic device is detected, the electronic device 100 determines the first search keyword to be a candidate search keyword.

The electronic device 100 stores the first search keyword as a target search keyword or a candidate search keyword depending on whether the selection input for selecting the search result from the search results is detected or input for viewing a list of the search results is detected.

If, as a result of the determination at step 911, it is determined that the first search keyword is not a target search keyword, the electronic device 100 determines the first search keyword to be a candidate search keyword and stores the candidate search keyword in a search keyword list at step 913.

If, as a result of the determination at step 911, it is determined that the first search keyword is a target search keyword, the electronic device 100 determines the first search keyword to be a target search keyword and stores the target search keyword in a search keyword list at operation 915.

The electronic device 100 detects that the connection with external electronic device is released at step 917.

When the connection with external electronic device is released, the electronic device 100 determines whether the user gesture at step 909 is detected in the search results of the electronic device 100 at step 919. In an embodiment of the present invention, when the connection with external electronic device is released, the electronic device 100 may perform an operation for maintaining the state in which the first search keyword has been determined to be a target search keyword or controlling the first search keyword so that it becomes a candidate search keyword depending on whether a user gesture is detected in the search results of the electronic device 100 or in the search results of the external electronic device.

If, as a result of the determination at step 919, it is determined that the user gesture at step 909 has been detected in the search results of the electronic device 100, the electronic device 100 maintains the state in which the first search keyword has been determined to be a target search keyword at step 921.

If, as a result of the determination at step 919, it is determined that the user gesture at step 909 has been detected in the search results of the external electronic device, the electronic device 100 controls the first search keyword to change from a target search keyword to a candidate search keyword and stores the candidate search keyword in the search keyword list at step 923. That is, the electronic device 100 changes the first search keyword, stored as the target search keyword, into the candidate search keyword and stores the candidate search keyword in the search keyword list.

An operation for determining a search keyword to be a target search keyword and/or a candidate search keyword depending on the connection state of the electronic device is described with reference to Table 2.

TABLE 2

| | Search results | | | | | |
|---|---|---|---|---|---|---|
| | and search keyword | | | | | |
| | list sharable | | | Only search keyword | | |
| | between electronic | | | list sharable between | | |
| | devices A and B | | | electronic devices A and B | | |
| | (connected) | | | (temporarily disconnected) | | |
| | | | Electronic | | | Electronic |
| | Valid | Valid | device A | Valid | Valid | device A |
| | search of | search of | stores | search of | search of | stores |
| | electronic | electronic | search | electronic | electronic | search |
| | device A? | device B? | keywords | device A? | device B? | keywords |
| Case 1 - | Y | N | Target | Y | N | Target |
| Search | | | search | | | search |
| keyword | | | keyword | | | keyword |
| “Keyword” | | | | | | |
| Case 2 - | N | Y | Target | N | Y | Candidate |
| Search | | | search | | | search |
| keyword | | | keyword | | | keyword |
| “Keyword” | | | | | | |
| Case 3 - | Y | Y | Target | Y | Y | Target |
| Search | | | search | | | search |
| keyword | | | keyword | | | keyword |
| “Keyword” | | | | | | |
| Case 4 - | N | N | Candidate | N | N | Candidate |
| Search | | | search | | | search |
| keyword | | | keyword | | | keyword |
| “Keyword” | | | | | | |

Referring to Table 2, the electronic device A and the electronic device B are connected through the communication unit 110. It is hereinafter assumed that the electronic device A is an electronic device now being used by a user and performs an operation for entering a search keyword and displaying search results, and the electronic device B is an external electronic device connected to the electronic device A. As described above, the electronic device A and the electronic device B may share a search keyword list and/or search results.

When the entry of the search keyword “Keyword” is detected in the search keyword entry region 201 through a search function, the electronic device A performs a search for the search keyword “Keyword.” Furthermore, the electronic device A requests a search for the search keyword “Keyword” from the electronic device B. The electronic device A receives the search results of the search keyword “Keyword” from the electronic device B in response to the search request. The electronic device A displays the search results obtained by performing the search and the search results received from the electronic device B.

In Case 1, the electronic device A may detect a selection input for selecting one of the search results of the electronic devices A and B displayed on the touch screen 130 of the electronic device A. In this case, if the selection input is detected in the search results of the electronic device A, the electronic device A determines the search keyword “Keyword” to be a target search keyword. If a release of the connection with electronic device B is detected, the electronic device A maintains the state in which the search keyword “Keyword” has been determined to be the target search keyword.

In Case 2, the electronic device A may detect a selection input for selecting one of the search results of the electronic devices A and B displayed on the touch screen 130 of the electronic device A. In this case, if the selection input for selecting one search result is detected in the search results of the electronic device B, the electronic device A determines the search keyword “Keyword” to be a target search keyword. When the release of the connection with electronic device B is detected, the electronic device A controls the search keyword “Keyword” determined to be a target search keyword to change into a candidate search keyword and store the candidate search keyword.

In Case 3, the electronic device A may detect selection input for selecting one of the search results of the electronic devices A and B displayed on the touch screen 130 of the electronic device A. In this case, if the selection input is detected in common search results of the electronic devices A and B, the electronic device A determines the search keyword “Keyword” to be a target search keyword. When the release of the connection with the electronic device B is detected, the electronic device A maintains the state in which the search keyword “Keyword” has been determined to be the target search keyword.

In Case 4, if a input for viewing one of the search results of the electronic devices A and B displayed on the touch screen 130 of the electronic device A is detected, the electronic device A stores the search keyword “Keyword” as a candidate search keyword. Furthermore, when the release of the connection with the electronic device B is detected, the electronic device A maintains the state in which the search keyword “Keyword” has been determined to be the candidate search keyword.

Subsequent operations are the same as step 311 to step 321 of FIG. 3 and are thus described in brief. If the first search keyword is determined to be a target search keyword, the electronic device 100 determines whether the first search keyword and the second search keyword previously stored in the search keyword list have continuity. If the first search keyword and the second search keyword have continuity, the electronic device 100 configures a search formula in which the first search keyword and the second search keyword have been combined. Furthermore, the electronic device 100 stores the search formula in the search keyword list. After the search formula is stored in the search keyword list, when input for selecting the search keyword entry region is detected, the electronic device 100 displays the search keyword list including the search formula. When input for selecting the search formula in the displayed search keyword list is detected, the electronic device 100 controls the display unit 131 to display the search results of the search formula. The electronic device 100 displays the search results of the search formula in preference to the search results of the first search keyword (or the second search keyword). That is, after displaying the search results of the search formula, the electronic device 100 may sequentially display the search results of the first search keyword and the search results of the second search keyword. For example, it is assumed that the first search keyword is “Time” and the second search keyword previously stored in the search keyword list is “Appointment.” The electronic device 100 determines the temporal and/or spatiotemporal continuity of the first search keyword “Time” and the second search keyword “Appointment.” If, as a result of the determination, the first search keyword “Time” and the second search keyword “Appointment” are found to have temporal and/or spatiotemporal continuity, the electronic device 100 configures a search formula “Time—Appointment” in which the first search keyword and the second search keyword previously stored in the search keyword list have been combined. Furthermore, the electronic device 100 stores the search formula “Time—Appointment” in the search keyword list. Next, when input for selecting the search keyword entry region displayed as a result of the execution of a search function is detected, the electronic device 100 controls the display unit 131 so that it displays the search keyword list. In this case, the electronic device 100 displays the search keyword list including the search formula “Time—Appointment.” When input for selecting the search formula “Time—Appointment” in the displayed search keyword list is detected, the electronic device 100 controls the display unit 131 to display the search results of the search formula “Time—Appointment.” Accordingly, the present invention can provide a search formula into which a user's intention has been incorporated, that is, the search formula in which the search keyword “Time” and the search keyword “Appointment” have been combined, and the search results of the search formula.

A method for providing a search keyword in an electronic device and an electronic device in accordance with various embodiments of the present invention have been described above through the specification and drawings. Although specific terms are used, the terms are merely used according to their common meanings in order to easily describe the technical contents of this invention and help in understanding of this invention, and this invention is not limited to the aforementioned embodiments of this invention. That is, it will be evident to those skilled in the art that various embodiments based on the technical spirit of this invention can be implemented.

Therefore, the scope of the present invention is defined not by the detailed description of the present invention, but by the appended claims and their equivalents, and thus, all differences within the scope and spirit will be construed as being included in the present invention.

What is claimed is:

1. A method for providing, by an electronic device, a search keyword, the method comprising:
displaying search results comprising at least one item in response to an entry of a first search keyword into a search keyword entry region;
determining continuity between the first search keyword and a second search keyword which is a search keyword entered prior to the first search keyword; and
storing at least one of the first search keyword and a search formula, in which the first search keyword and the second search keyword have been combined in a search keyword list, in response to the determination of the continuity between the first search keyword and the second search keyword.

2. The method of claim 1, wherein displaying the search results comprises:
detecting a selection input for the at least one item of the search results; and
determining the first search keyword to be a target search keyword in response to the selection input.

3. The method of claim 2, wherein when the selection input for the at least one item of the search results is not detected and the first search keyword is deleted from the search keyword entry region or a search function is terminated, the first search keyword is determined to be a candidate search keyword and is stored in the search keyword list.

4. The method of claim 1, wherein determining the continuity comprises determining at least one of temporal continuity and spatiotemporal continuity.

5. The method of claim 4, wherein when a search for the second search keyword is performed in the electronic device within a predetermined time span from a time when the first search keyword is entered and the second search keyword is entered, the first search keyword and the second search keyword are determined to have temporal continuity, and
wherein the second keyword is a search keyword previously stored in the search keyword list.

6. The method of claim 4, wherein when the second search keyword is a target search keyword, a process of determining continuity is not performed and the first search keyword is stored in the search keyword list.

7. The method of claim 1, wherein storing at least one of the first search keyword and the search formula in the search keyword list comprises:
when the second search keyword is a candidate search keyword, deleting the second search keyword from the search keyword list,
replacing the entered first search keyword with the search formula, and
storing the search formula in the search keyword list.

8. The method of claim 1, further comprising sequentially displaying search results of the search formula and search results of the first search keyword included in the search formula when the search formula is selected in the search keyword list.

9. The method of claim 4, wherein when the electronic device requests a search for the second search keyword from an external electronic device within a predetermined time span from a time when the first search keyword is entered and the second search keyword is entered, the first search keyword and the second search keyword are determined to have the spatiotemporal continuity, and
wherein the second keyword is a search keyword previously stored in the search keyword list.

10. The method of claim 9, further comprising determining the first search keyword to be a target search keyword, when the electronic device has requested a search for the first search keyword from the external electronic device and the at least one item selected from the search results is a search result shared by the external electronic device.

11. The method of claim 10, wherein when the connection between the electronic device and the external electronic device is released in a state in which the first search keyword has been determined to be the target search keyword in the search keyword list, the electronic device changes the first search keyword into a candidate search keyword and stores the candidate search keyword.

12. The method of claim 3, wherein when keywords are automatically deleted from the search keyword list due to a storage time limit, the candidate search keyword is deleted from the search keyword list in preference to a previously stored target search keyword.

13. An electronic device, comprising:
a communication unit configured to connect the electronic device and an external electronic device;
a storage unit configured to store a search keyword entered into a search keyword entry region and a search keyword list received from the external electronic device;
a touch screen configured to display search results including at least one item in response to the entry of a first search keyword into the search keyword entry region; and
a control unit configured to determine continuity between the first search keyword and a second search keyword entered prior to the first search keyword and to store at least one of the first search keyword and a search formula, in which the first search keyword and the second search keyword have been combined in a search keyword list, in response to the determination of the continuity between the first search keyword and the second search keyword.

14. The electronic device of claim 13, wherein the control unit is further configured to:
when the selection input for the at least one item of the search results is detected and determine the first search keyword to be a target search keyword in response to the selection input,
when the selection input for the at least one item of the search results is not detected and the first search keyword is deleted from the search keyword entry region or a search function is terminated, perform control so that the first search keyword is determined to be a candidate search keyword and is stored in the search keyword list.

15. The electronic device of claim 13, wherein the control unit is further configured to perform control so that at least one of temporal continuity and spatiotemporal continuity between the first search keyword and the second search keyword is determined.

16. The electronic device of claim 15, wherein the control unit is further configured to, when a search for the second search keyword is performed in the electronic device within a predetermined time span from a time when the first search keyword is entered and the second search keyword is entered, determine that the first search keyword and the second search keyword have temporal continuity, and when the second search keyword is a target search keyword, perform control so that the first search keyword is stored in the search keyword list without determining continuity,
wherein the second keyword is a search keyword previously stored in the search keyword list.

17. The electronic device of claim 13, wherein the control unit is further configured to perform control so that when the second search keyword is a candidate search keyword, the second search keyword is deleted from the search keyword list, the entered first search keyword is replaced with the search formula, and the search formula is stored in the search keyword list, and when the search formula is selected in the search keyword list, search results of the search formula and search results of the first search keyword included in the search formula are sequentially displayed.

18. The electronic device of claim 15, wherein the control unit is further configured to, when the electronic device requests a search for the second search keyword from the external electronic device within a predetermined time span from a time when the first search keyword is entered, and the second search keyword is entered, determine that the first search keyword and the second search keyword have spatiotemporal continuity, and
wherein the second keyword is a search keyword previously stored in the search keyword list.

19. The electronic device of claim 18, wherein the control unit is further configured to determine that the first search keyword is a target search keyword, when the electronic device has requested a search for the first search keyword from the external electronic device and the at least one item selected from the search results is a search result shared by the external electronic device.

20. The electronic device of claim 19, wherein the control unit is further configured to, when the connection between the electronic device and the external electronic device is released in a state in which the first search keyword has been determined to be the target search keyword in the search keyword list, perform control so that the electronic device changes the first search keyword into a candidate search keyword and stores the candidate search keyword.
